(19) United States
(12) Patent Application Publication
(10) Pub. No.: US 2021/0365533 A1
(43) Pub. Date: Nov. 25, 2021

(54) SYSTEMS AND METHODS FOR AUTHENTICATING A USER OF A HEAD-MOUNTED DISPLAY

(71) Applicant: Facebook Technologies, LLC, Menlo Park, CA (US)

(72) Inventors: Kirsten Kaplan, Redmond, WA (US); Michael Hegg, Seattle, WA (US)

(21) Appl. No.: 17/320,180

(22) Filed: May 13, 2021

Related U.S. Application Data
(60) Provisional application No. 63/027,777, filed on May 20, 2020.

(51) Int. Cl. G06F 21/32; G06K 9/00; G02B 27/01; G06N 3/08

(52) U.S. Cl. CPC G06F 21/32; G06K 9/00617; G06K 9/0061; G02B 2027/0138; G02B 27/0172; G02B 27/0101; G06N 3/08; G06K 9/00604

(57) ABSTRACT

A disclosed computer-implemented method may include, at a head-mounted display that includes a camera assembly configured to receive light reflected from a periocular region of a user, capturing, via the camera assembly, an image of the periocular region of the user. The image of the periocular region of the user may include at least one attribute that is outside of a range defined in a known iris recognition standard. The computer-implemented method may also include identifying at least one biometric identifier included in the image of the periocular region of the user and performing at least one security action based on identifying the biometric identifier included in the image of the periocular region of the user.

### CROSS REFERENCE TO RELATED APPLICATION

This application claims the benefit of U.S. Provisional Application No. 63/027,777, filed May 20, 2020, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an example system for authenticating a user of a head-mounted display (HMD).

FIG. 2 is a block diagram of an example implementation of a system for authenticating a user of an HMD.

FIG. 3 is a flow diagram of an example method for authenticating a user of an HMD.

FIG. 4 is a view of an example periocular region of a user.

FIG. 5 is a view of an example image of a periocular region of a user that may be used in connection with embodiments of this disclosure.

FIG. 6 is a view of an example image of a periocular region of a user with features identified in accordance with embodiments of this disclosure.

FIG. 7 is a flow diagram of an example implementation of a method for authenticating a user of an HMD.

FIG. 8 is an illustration of a waveguide display in accordance with embodiments of this disclosure.

FIG. 9 is an illustration of an example artificial-reality headband that may be used in connection with embodiments of this disclosure.

FIG. 10 is an illustration of example augmented-reality glasses that may be used in connection with embodiments of this disclosure.

FIG. 11 is an illustration of an example virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Putting on an artificial reality headset (e.g., a virtual reality and/or an augmented reality headset) may be the beginning of a thrilling experience, one that may be more immersive than almost any other digital entertainment or simulation experience available today. Such headsets may enable users to travel through space and time, interact with friends in a three-dimensional world, or play video games in a radically redefined way. Artificial reality headsets may also be used for purposes other than recreation. Governments may use them for military training simulations, doctors may use them to practice surgery, and engineers may use them as visualization aids. Artificial reality headsets may also be used for productivity purposes. Information organization, collaboration, and privacy may all be enabled or enhanced through the use of artificial reality headsets.

Security and/or personalization of artificial reality experiences may be enhanced by various conventional user authentication techniques. However, artificial reality headsets may be poorly adapted for use of conventional user authentication methods such as usernames and/or passwords entered via keyboards. Furthermore, hardware included within artificial reality headsets may be inadequate for some conventional biometric identification techniques. For example, images captured via imaging devices already often included in head mounted displays (e.g., eye-tracking cameras) may be poorly composed, of insufficient quality, and/or of insufficient resolution for use in conventional iris recognition methods. Hence, the instant application addresses a need for improved systems and methods for authenticating users of HMDs.

The present disclosure is generally directed to systems and methods for authenticating a user of an HMD. As will be explained in greater detail below, embodiments of the instant disclosure may capture, via a camera assembly included in an HMD and configured to receive light reflected from a periocular region of a user, an image (e.g., a still image, a video stream, a video file, etc.) of the periocular region of the user. However, the image of the periocular region of the user may include at least one attribute (e.g., a resolution, a pixel aspect ratio, a spatial sampling rate, a content of the image, etc.) that is outside of a range defined in a known iris recognition standard.

Embodiments of the systems and methods described herein may further identify at least one biometric identifier included in the image of the periocular region of the user, such as a pattern of an iris of the user, a feature vector from the image of the periocular region of the user, and so forth. In some examples, embodiments may identify the biometric identifier of the user by analyzing the image of the periocular region of the user in accordance with a machine learning model (e.g., an artificial neural network, a convolutional neural network, etc.).

Some embodiments may further perform at least one security action based on identifying the biometric identifier included in the image of the periocular region of the user. The security action may include, for example, providing the user with access to a feature of the HMD, preventing the user from accessing the feature of the HMD, and so forth.

By identifying biometric identifiers of users of HMDs, the systems and methods described herein may improve security and/or personalization of artificial reality experiences presented by way of HMDs. Furthermore, by using existing camera assemblies that may already be included in HMDs for biometric user authentication, the systems and methods described herein may improve user authentication while minimizing cost and/or complexity of HMD designs and/or implementations.

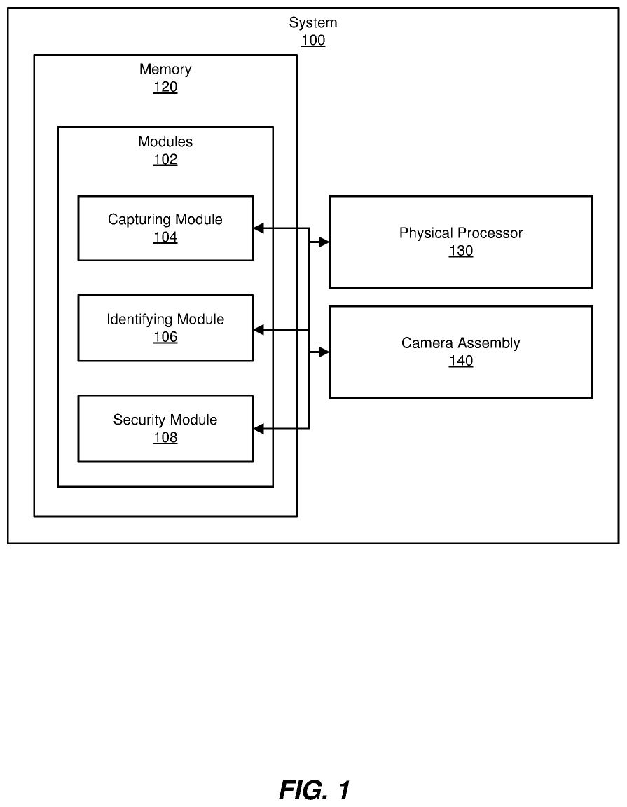

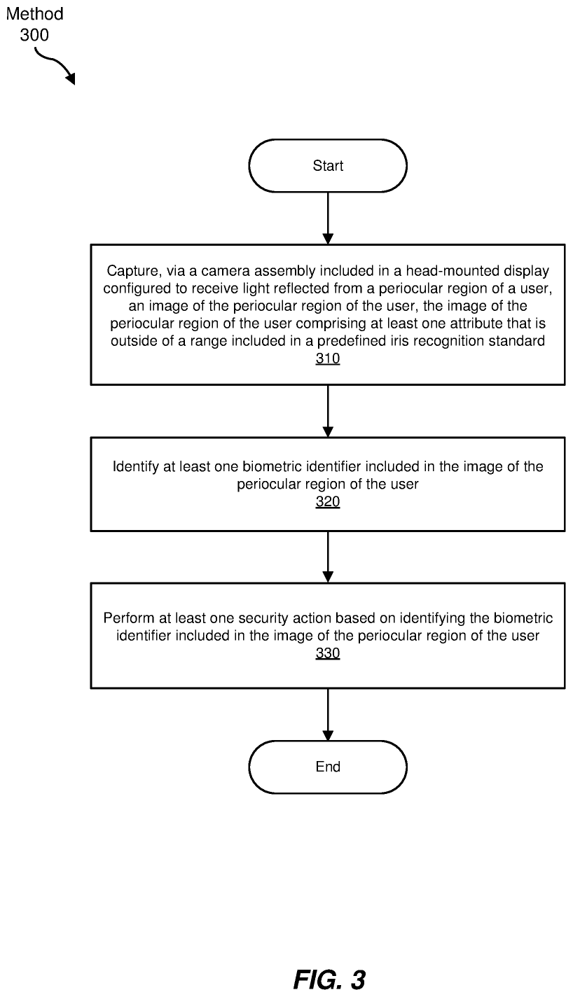

The following will provide, with reference to FIGS. 1-2 and 4-11, detailed descriptions of systems for authenticating a user of an HMD. Detailed descriptions of corresponding computer-implemented methods will also be provided in connection with FIG. 3.

FIG. 1 is a block diagram of an example system 100 for authenticating a user of an HMD. As illustrated in this figure, example system 100 may include one or more modules 102 for performing one or more tasks. As will be explained in greater detail below, modules 102 may include a capturing module 104 that may capture, via a camera assembly included in an HMD and configured to receive light reflected from a periocular region of a user, an image of the periocular region of the user, the image of the periocular region of the user comprising at least one attribute that is outside of a range defined in a known iris recognition standard. Example system 100 may also include an identifying module 106 that may identify at least one biometric identifier included in the image of the periocular region of the user. As also shown in FIG. 1, example system 100 may further include a security module 108 that may perform at least one security action based on identifying the biometric identifier included in the image of the periocular region of the user.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented or software-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate authenticating a user of an HMD. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As further shown in FIG. 1, in some embodiments, example system 100 may also include a camera assembly 140. Camera assembly 140 may include any suitable device configured to capture an image or set of images (e.g., a still image, a video stream, a video file, etc.) from light received by the device. In some examples, camera assembly 140 may include a global-shutter camera. In some examples a “global-shutter camera” may include any imaging device that may scan an entire area of an image sensor (e.g., an array of photosensitive elements or pixels) simultaneously. In additional embodiments, camera assembly 140 may include a rolling-shutter camera. In some examples, a “rolling-shutter camera” may include any imaging device that may scan an area of an image sensor (e.g., an array of photosensitive elements or pixels) line-by-line over a period of time (e.g., 60 Hz, 90 Hz, 120 Hz, etc.).

In additional or alternative embodiments, camera assembly 140 may include an event camera. In some examples, an “event” may include any change greater than a threshold value in one or more qualities of light (e.g., wavelength, brightness, radiance, polarity, luminance, illuminance, luminous intensity, luminous power, spectral exposure, etc.) received by a pixel included in an event camera during a predetermined period (e.g., 1 μs, 10 μs, 100 μs, 1000 μs, etc.). In some examples, an “event camera” may include any sensor that may asynchronously gather and transmit pixel-level data from one or more pixels in an image sensor array that may detect an event during a particular period of time (e.g., 1 μs, 10 μs, 100 μs, 1000 μs, etc.).

Camera assembly 140 may be positioned to receive light reflected by a periocular region of a user. Furthermore, camera assembly 140 may be communicatively coupled via any suitable data channel to physical processor 130. In some examples, camera assembly 140 may be separate and distinct from an HMD. In additional or alternative examples, camera assembly 140 may be included in (e.g., integrated within, positioned within, physically coupled to, etc.) an HMD.

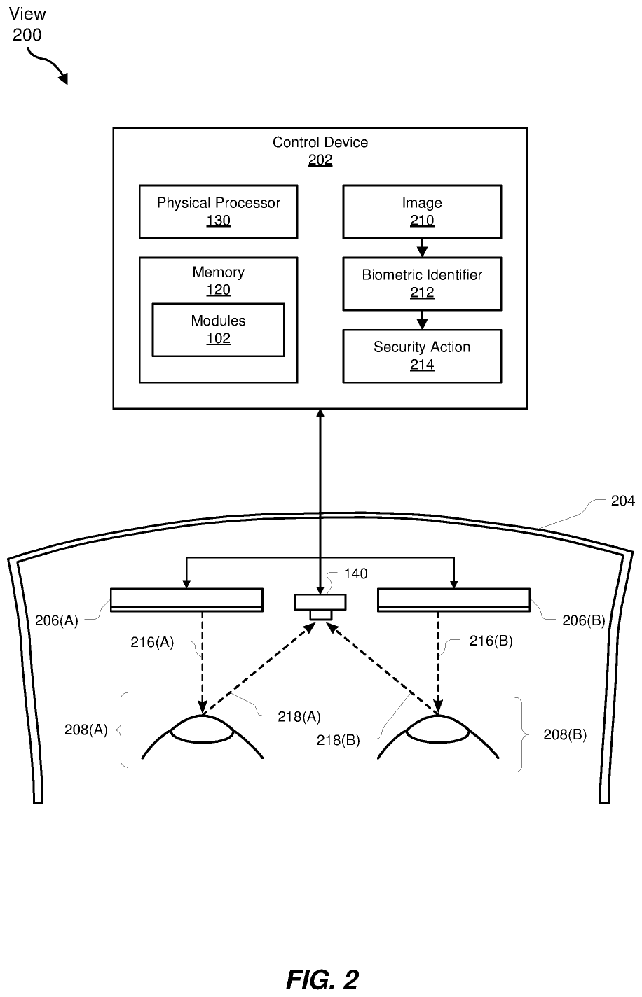

Example system 100 in FIG. 1 may be implemented in a variety of ways. For example, all or a portion of example system 100 may represent portions of an example system 200 (“system 200”) in FIG. 2. As shown in FIG. 2, system 200 may include control device 202. System 200 may also include an HMD 204. In some examples, as will be described in greater detail below, a “head-mounted display” may include any type or form of display device or system that may be worn on or about a user's head and that may display visual content to the user. HMDs may display content in any suitable manner, including via a display screen (e.g., an LCD or LED screen), a projector, a cathode ray tube, an optical mixer, a waveguide display, etc. HMDs may display content in one or more of various media formats. For example, an HMD may display video, photos, and/or computer-generated imagery (CGI).

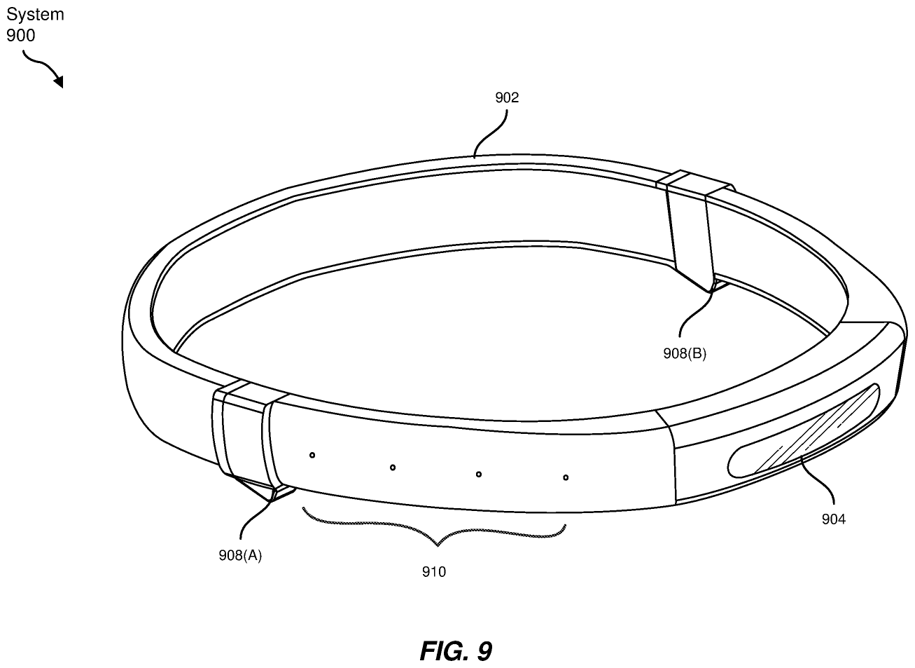

HMDs may provide diverse and distinctive user experiences. Some HMDs may provide virtual-reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through), which may result in augmented reality or mixed reality experiences. HMDs may be configured to be mounted to a user's head in a number of ways. Some HMDs may be incorporated into glasses or visors. Other HMDs may be incorporated into helmets, hats, or other headwear. Various examples of artificial reality systems that may include one or more HMDs may be described in additional detail below in reference to FIGS. 9-11.

HMD 204 may include an illumination source 206 (e.g., illumination source 206(A) and/or illumination source 206(B)). As will be described in greater detail below, illumination source 206 may include any suitable illumination source that may illuminate at least a portion of a periocular region of a user with light in any suitable portion of an electromagnetic spectrum (e.g., visible light, infrared light, ultraviolet light, etc.).

In some examples, illumination source 206 may include a plurality of illuminator elements (e.g., 2 illuminator elements, 4 illuminator elements, 16 illuminator elements, 100 illuminator elements, etc.). Each illuminator element may be associated with an illumination attribute that may distinguish the illuminator element from other illuminator elements included in the plurality of illuminator elements during an illumination sequence. For example, an illumination attribute may include, without limitation, a pulse time offset (e.g., 1 μs, 10 μs, 100 μs, 1000 μs, etc.), a pulse code (e.g., a pattern of pulses during the illumination sequence), a pulse frequency (e.g., 1 Hz, 100 Hz, 1 kHz, 1 MHz, etc. during the illumination sequence), a polarization, a wavelength (e.g., 1 nm, 10 nm, 100 nm, 1 μm, 100 μm, 1 mm, etc.), combinations of one or more of the same, and so forth. Although illustrated as part of (e.g., integrated within, positioned within, physically coupled to, etc.) HMD 204 in FIG. 2, in additional or alternative examples, illumination source 206 may be separate and distinct from an HMD.

In some examples, as further shown in FIG. 2, HMD 204 may also include camera assembly 140. As further shown in FIG. 2, HMD 204 may be worn by a user having at least one periocular region 208 (e.g., periocular region 208(A) and/or periocular region 208(B)). When the user wears HMD 204, each illumination source 206 may be positioned to direct and/or project light (e.g., light from at least one of illumination source 206(A) or illumination source 206(B)) towards a periocular region 208. Likewise, camera assembly 140 may be positioned to receive light reflected from periocular region 208.

Hence, when a user wears HMD 204 as shown in FIG. 2, illumination source 206(A) may illuminate periocular region 208(A). Periocular region 208(A) may reflect light from illumination source 206(A) towards camera assembly 140, and camera assembly 140 may receive light reflected by periocular region 208(A). Likewise, when the user wears HMD 204 as shown in FIG. 2, illumination source 206(B) may illuminate periocular region 208(B). Periocular region 208(B) may reflect light from illumination source 206(B) towards camera assembly 140, and camera assembly 140 may receive light reflected by periocular region 208(A). Furthermore, as will be described in greater detail below in reference to FIGS. 9-11, while not shown in FIG. 2, HMD 204 may include one or more electronic elements, including one or more inertial measurement units (IMUS), one or more tracking emitters or detectors, one or more touch sensors, one or more proximity sensors, and/or any other suitable sensor, device, or system for creating an artificial reality experience.

In at least one example, control device 202 may be programmed with one or more of modules 102. In at least one embodiment, one or more modules 102 from FIG. 1 may, when executed by control device 202, enable control device 202 to perform one or more operations to authenticate a user of an HMD. For example, as will be described in greater detail below, capturing module 104 may cause control device 202 to capture, via a camera assembly included in an HMD (e.g., camera assembly 140) and configured to receive light reflected from a periocular region of a user (e.g., periocular region 208(A) and/or periocular region 208(B)), an image of the periocular region of the user (e.g., image 210). The image of the periocular region of the user may include at least one attribute that is outside of a range defined in a known iris recognition standard.

In some embodiments, identifying module 106 may cause control device 202 to identify at least one biometric identifier (e.g., biometric identifier 212) included in the image of the periocular region of the user. Additionally, in some examples, security module 108 may cause control device 202 to perform at least one security action (e.g., security action 214) based on identifying the biometric identifier included in the image of the periocular region of the user.

By way of illustration, one or more of modules 102 may cause control device 202 to direct an illumination source 206 (e.g., illumination source 206(A) and/or illumination source 206(B)) to illuminate, via a source light 216 (e.g., source light 216(A) and/or source light 216(B)) emitted by an illumination source 206 (e.g., illumination source 206(A) and/or illumination source 206(B)), a periocular region 208 (e.g., periocular region 208(A) and/or periocular region 208(B)). The periocular region 208 may reflect reflected light 218 (e.g., reflected light 218(A) and/or reflected light 218(B)) toward camera assembly 140. Camera assembly 140 may receive reflected light 218, and capturing module 104 may cause computing device 202 to capture image 210 of periocular region 208 from reflected light 218. Identifying module 106 may then cause computing device 202 to identify biometric identifier 212 included in image 210, and security module 108 may cause computing device 202 to perform at least one security action based on identifying module 106 identifying biometric identifier 212 included in image 210.

Control device 202 generally represents any type or form of computing device capable of reading and/or executing computer-executable instructions. Examples of control device 202 include, without limitation, embedded systems, wearable devices (e.g., smart watches, smart glasses, etc.), servers, desktops, laptops, tablets, cellular phones, (e.g., smartphones), personal digital assistants (PDAs), multimedia players, gaming consoles, combinations of one or more of the same, or any other suitable computing device. In some examples, control device 202 may be communicatively coupled to HMD 204 and/or camera assembly 140. In some examples, control device 202 may be included in (e.g., physically integrated as part of) HMD 204. In additional examples, control device 202 may be physically separate and/or distinct from HMD 204 and may be communicatively coupled to HMD 204 and/or camera assembly 140 via any suitable data pathway.

In at least one example, control device 202 may include at least one computing device programmed with one or more of modules 102. All or a portion of the functionality of modules 102 may be performed by control device 202 and/or any other suitable computing system. As will be described in greater detail below, one or more of modules 102 from FIG. 1 may, when executed by at least one processor of control device 202, may enable control device 202 to authenticate a user of an HMD in one or more of the ways described herein.

Many other devices or subsystems may be connected to example system 100 in FIG. 1 and/or example system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Example systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for authenticating a user of an HMD. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may capture, via a camera assembly included in an HMD and configured to receive light reflected from a periocular region of a user, an image of the periocular region of the user. For example, capturing module 104 may, as part of computing device 202, cause computing device 202 to capture, via camera assembly 140 included in HMD 204 and configured to receive reflected light 218 (e.g., reflected light 218(A) and/or reflected light 218(B)) reflected from a periocular region 208 (e.g., periocular region 208(A) and/or periocular region 208(B)).

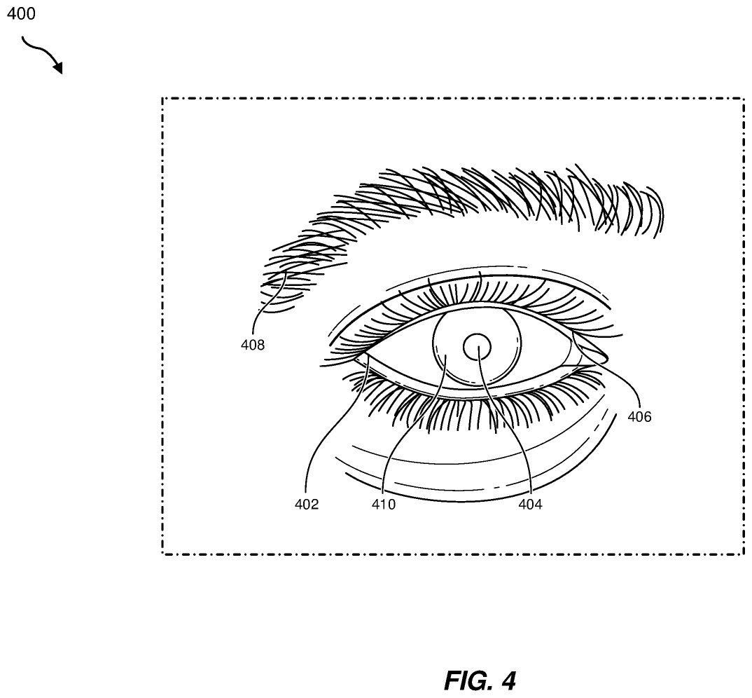

In some examples, a periocular region of a user may include any region of a body or face of a user that is situated or occurs within or around an eye or eyeball of a user. A periocular region of a user may include, without limitation, a periorbital region of the user, an orbital region of the user, any skin, muscle, hair, and/or other tissue that may be situated or may occur within or around an eye or eyeball of a user, one or more eyebrows of the user, one or more eyelids of the user, one or more eyelashes of the user, one or more eyes of the user, parts of one or more of the same, and so forth. By way of illustration, FIG. 4 is a view of an example periocular region 400 of a user. As shown, periocular region 400 may include an eye 402, a pupil 404, an eyelid 406, an eyebrow 408, an iris 410, and so forth.

In at least one example, one or more of modules 102 (e.g., capturing module 104) may further cause control device 202 to direct an illumination source (e.g., an illumination source included within HMD 204) to illuminate a periocular region 208 such that light from the illumination source illuminates periocular region 208. Furthermore, periocular region 208 may reflect light such that camera assembly 140 receives light reflected from periocular region 208. Hence, by directing the illumination source to illuminate periocular region 208, one or more of modules 102 may cause periocular region 208 to be illuminated and/or may cause camera assembly 140 to receive light reflected by periocular region 208.

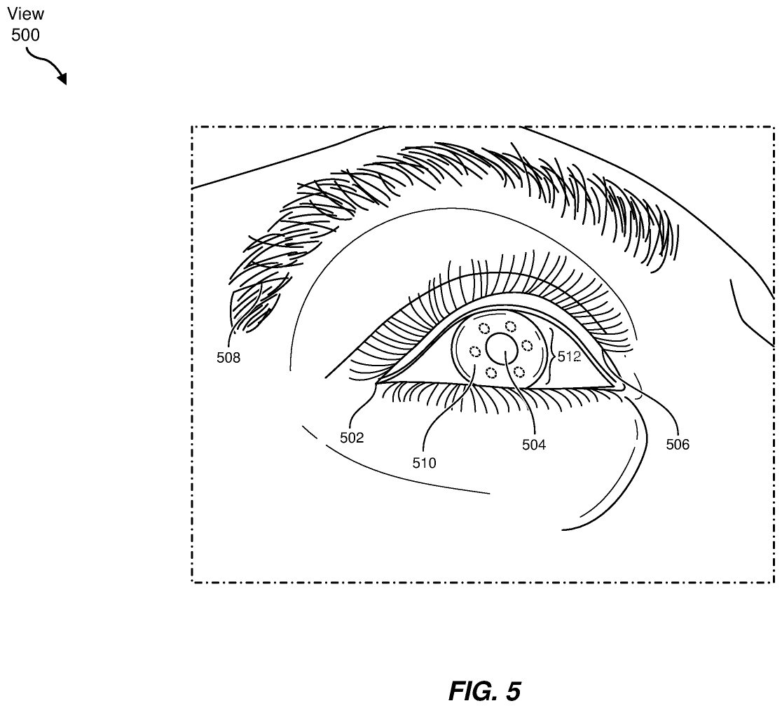

As mentioned above, camera assembly 140 may be positioned to receive light reflected from a periocular region 208 (e.g., periocular region 208(A) and/or periocular region 208(B)), and hence to capture an image or set of images of the periocular region 208. By way of illustration, FIG. 5 is a view of an example image 500 of a periocular region of a user that a camera assembly 140 may capture. As shown, example image 500 may include an eye image 502, a pupil image 504, an eyelid image 506, an eyebrow image 508 an iris image 510, and a reflection 512 that may include one or more reflections of one or more elements included in an illumination source 206 (e.g., illumination source 206(A) and/or illumination source 206(B)).

It may be noted that, although illustrated as singular images throughout this disclosure, embodiments of the systems and methods described herein may also encompass, apply to, and/or be implemented via sets of multiple images such as video streams and/or video files. Hence, in some examples, an “image of a periocular region” such as image 210, example image 500, example image 600, and so forth, may include a plurality of images. Further, camera assembly 140 may be configured to capture a set of images representative of a periocular region such as, without limitation, a video file, a video stream, a multi-view capture of a periocular region, and/or any other suitable collection of image data that may include information representative of one or more periocular regions.

Unfortunately, an image or set of images captured by camera assembly 140 (e.g., image 210, example image 500, etc.) may include one or more attributes that may make the image or set of images unsuitable for use in one or more conventional biometric authentication techniques. For example, the International Organization for Standardization (ISO) and/or the International Electrotechnical Commission (IEC) has developed, promulgated, and/or promoted a set of widely used iris recognition standards. An example may be ISO/IEC Standard 29794-6:2015, entitled “Information technology Biometric sample quality Part 6: Iris image data”. This iris recognition standard may define and/or include various ranges for attributes for images to be used in conventional iris recognition techniques. For example, and not by way of limitation, ISO/IEC Standard 29794-6:2015 may require iris data images to have a resolution of at least 640 pixels by 480 pixels, a spatial sampling rate of at least 15.7 pixels per millimeter, a pixel aspect ratio of at least 0.99:1 and/or at most 1.01:1, an optical distortion less than a predetermined distortion threshold, a sharpness greater than a predetermined sharpness threshold, a sensor signal-to-noise ratio of at least 36 dB, and so forth. Furthermore, in accordance with ISO/IEC Standard 29794-6:2015, and without limitation, a suitable iris image should include at least 70 percent of the iris of a user, a radius portion of the iris in the iris image should include at least 80 pixels, a concentricity of the iris in the image and a pupil in the image should be at least 90 percent, and a ratio of the iris in the image to the pupil in the image should be at least 20 percent and/or less than 70 percent.

An image or set of images captured by camera assembly 140 may have one or more attributes that may be outside of one or more of the ranges defined in a known iris recognition standard such as ISO/IEC Standard 29794-6:2015. For example, example image 500 in FIG. 5 may have a resolution of less than 640 pixels by 480 pixels and/or an optical distortion of greater than a predetermined optical distortion threshold. Additionally or alternatively, iris image 510 may include less than 70 percent of the iris of the user, a radius of iris image 510 may be less than 80 pixels, and/or a ratio of a portion of the user's iris included in iris image 510 to a portion of the user's pupil in pupil image 504 may be less than 20 percent or greater than 70 percent. Hence, example image 500 may be unsuitable for use in accordance with the predefined iris recognition standard of ISO/IEC Standard 29794-6:2015.

Returning to FIG. 3, at step 320, one or more of the systems described herein may identify at least one biometric identifier included in the image of the periocular region of the user. For example, identifying module 106 may, as part of computing device 202 in FIG. 2, identify biometric identifier 212 included in image 210 of a periocular region 208 of the user.

In some embodiments, a “biometric identifier” may include any distinctive and/or measurable characteristic of a person that may be used to identify the person. Examples, of biometric attributes include, without limitation, fingerprints, palm vein patterns, facial features, DNA sequences, palm prints, hand geometry, iris patterns, retina blood vessel patterns, odor and/or scent profiles, typing rhythms, speaking rhythms, gaits, postures, and/or voice patterns.

Identifying module 106 may identify at least one biometric identifier (e.g., biometric identifier 212) included in an image of a periocular region of a user (e.g., image 210 of a periocular region 208) in a variety of contexts. For example, in at least one embodiment, image 210 may include at least a portion of an iris of a user (e.g., iris image 510), and identifying module 106 may identify an iris of a user from the image of the iris of the user that may be included in image 210.

Identifying module 106 may identify an iris of a user in any suitable way. For example, in accordance with an approach suggested by John Daugman of the University of Cambridge, identifying module 106 may identify an iris of a user by segmenting an acquired image of an iris of a user (e.g., an image of iris 410) to identify limbus and/or pupilary boundaries, noise regions such as eyelids, eyelashes, and/or specular reflections, and so forth. This segmentation step may be critical to the Daugman approach as inaccurate segmentation may compromise later pattern matching operations.

Furthermore, identifying module 106 may normalize an image of an iris by unwrapping the image into polar coordinates with a normalized radius r within a range from 0 to 1 (e.g., r: [0,1]) and a normalized angle θ within a range from 0 to 2π (e.g., 0: [0,2π]). Dilation and/or constriction of an elastic meshwork of an iris may be modeled as stretching of a homogeneous rubber sheet having the topology of an annulus anchored along its outer perimeter with tension controlled by an off-centered interior ring of a variable radius. This homogenous rubber sheet model may assign to each point on the iris, regardless of the size or pupillary dilation of the iris, a pair of real coordinates (r, θ) where r is on the unit interval [0,1] and θ is on an interval of [0,2π]. This may normalize iris area against pupil dilation. Additionally, normalizing the image of the iris in this way may account for varying iris radius (e.g., due to non-concentric pupil and iris centers). A resulting normalized template may also enable rotation correction. Additionally or alternatively, in some examples, identifying module 106 may normalize an image of the iris by enhancing a contrast of the image.

Identifying module 106 may also encode features within a normalized image of an iris in a variety of contexts. For example, identifying module 106 may filter a normalized image of an iris using a Gabor wavelet transform (e.g., a 2-D Gabor filter, a 2-D Log-Gabor filter, etc.). The result of such a transform may be a set of complex numbers that may carry a local amplitude and/or phase information pattern. An example of a Log-Gabor function may be defined in accordance with the following:

$$G ( u , v ) = exp ( - \frac{ln {( \frac{{u}_{1}}{{f}_{0}} )}^{2}}{2 ln {( \frac{{σ}_{u}}{{f}_{0}} )}^{2}} ) \cdot exp ( - \frac{{v}_{1}^{2}}{2 {σ}_{v}^{2}} )$$

Identifying module 106 may also convolve an image with a Gabor filter bank using multiple filter scales and orientations. In some examples, identifying module 106 may convolve an image comprising a raw iris image in a dimensionless polar coordinate system I(ρ,ϕ) with multiple filter banks that may be expressed as g(ρ,ϕ) in accordance with the following:

h_{{Re,Im}}=sgn_{{Re,Im}}[I(ρ,ϕ)*g(ρ,ϕ)]

where h_{{Re,Im}} may be a complex-valued bit with real and imaginary parts that may be either 1 or 0 (sgn) depending on the sign of a result of the convolution. This may result in an extraction of phase information in four quadrants [1,1], [1,0], [0,0], and/or [0,1]. Identifying module 106 may therefore generate a phase quadrant coding sequence, “phase code,” or “iris code” that may correspond to a pattern of an iris (e.g., a pattern of iris 410). In some examples, identifying module 106 may further compute, for each phase code or iris code, an equal number of masking bits to signify whether any iris region may be omitted from a matching process (e.g., an iris within the image of the periocular region may be obscured by eyelids, the image may contain eyelash occlusions, specular reflections, boundary artifacts (e.g., from hard contact lenses), poor signal-to-noise ratio, etc.).

Identifying module 106 may also determine whether an iris code (e.g., an iris code corresponding to iris 410) matches a predetermined iris code (e.g., an already-known iris code, such as from a previous iris capture and/or recognition process). For example, in accordance with a Daugman-type process, identifying module 106 may compute a Hamming Distance between the iris code and a predetermined iris code to determine a similarity and/or dissimilarity of the iris code and the predetermined iris code. In some examples, identifying module 106 may compute the Hamming Distance (HD) in accordance with the following:

$$H D = \frac{‖ ( codeA ⊕ codeB ⋂ maskA ⋂ maskB ‖}{‖ maskA ⋂ maskB ‖}$$

where codeA and codeB may denote bit phase vectors respectively representative of an iris code and a predetermined iris code. Additionally, maskA and maskB may respectively denote mask bit vectors associated with the iris code and the predetermined iris code. Furthermore, Boolean operator ⊕ may denote an exclusive-OR operator (XOR) and ∩ may denote a set-theoretic intersection (e.g., an AND operator). Identifying module 106 may measure the above norms (e.g., ∥∥) of the resultant bit vector and of the combined (e.g., AND'ed) mask bit vectors to compute a fractional Hamming Distance as a measure of dissimilarity between the iris code (e.g., the iris code of iris 410) and the predetermined (e.g., already known) iris code.

Unfortunately, images captured by capturing module 104 may be unsuitable for a Daugman-type iris recognition method. For example, as noted above, example image 500 in FIG. 5 may have a resolution of less than 640 pixels by 480 pixels and/or an optical distortion of greater than a predetermined optical distortion threshold. Additionally or alternatively, iris image 510 may include less than 70 percent of the iris of the user, a radius of iris image 510 may be less than 80 pixels, and/or a ratio of a portion of the user's iris included in iris image 510 to a portion of the user's pupil in pupil image 504 may be less than 20 percent or greater than 70 percent. Hence, example image 500 may be unsuitable for use in accordance with a Daugman-type iris recognition method predefined iris recognition standard of ISO/IEC Standard 29794-6:2015.

In order to overcome some of these limitations, in some embodiments, identifying module 106 may employ one or more advanced techniques to identify a biometric identifier from an image or set of images of a periocular region. For example, identifying module 106 may identify biometric identifier 212 by extracting a feature vector from image 210 of periocular region 208. In some examples, biometric identifier 212 may include a feature vector extracted from image 210 of periocular region 208.

In some examples, a “feature vector” and/or a “feature descriptor” may include any information that describes one or more properties of an image feature. For example, a feature vector may include two-dimensional coordinates of a pixel or region of pixels included in an image that may contain a detected image feature. Additionally or alternatively, a feature descriptor may include a result of a feature description algorithm applied to an image feature and/or an area of the image surrounding the image feature. As an example, a Speed Up Robust Feature (SURF) feature descriptor may be generated based on an evaluation of an intensity distribution of pixels within a “neighborhood” of an identified point of interest.

In some examples, an “image feature,” “keypoint,” “key location,” and/or “interest point” may include any identifiable portion of an image that includes information that may be relevant for a computer vision and/or relocalization process, and/or that may be identified as an image feature by at least one feature detection algorithm. In some examples, an image feature may include specific structures included in and/or identified based on pixel data included in an image, such as points, edges, lines, junctions, or objects. Additionally or alternatively, an image feature may be described in terms of properties of a region of an image (e.g., a “blob”), a boundary between such regions, and/or may include a result of a feature detection algorithm applied to the image.

Many feature detection algorithms may also include and/or may be associated with feature description algorithms. For example, the Scale Invariant Feature Transform (SIFT) algorithm includes both a feature detection algorithm, based on a Difference of Gaussians feature detection algorithm, as well as a “keypoint descriptor” feature description algorithm which, in general, extracts a 16×16 neighborhood surrounding a detected image feature, subdivides the neighborhood into 4×4 sub-blocks, and generates histograms based on the sub-blocks, resulting in a feature descriptor with 128 values. As another example, the Oriented FAST and Rotated BRIEF (ORB) algorithm uses a variation of the FAST corner detection algorithm to detect image features, and generates feature descriptors based on a modified version of a Binary Robust Independent Elementary Features (BRIEF) feature description algorithm. Additional examples of feature detection algorithms and/or feature description algorithms may include, without limitation, Speed Up Robust Feature (SURF), KAZE, Accelerated-KAZE (AKAZE), Binary Robust Invariant Scalable Keypoints (BRISK), Gradient Location and Orientation Histogram (GLOH), histogram of oriented gradients (HOG), Multiscale Oriented Patches descriptor (MOTS), variations or combinations of one or more of the same, and so forth.

Identifying module 106 may extract a feature vector from image 210 in any suitable way, such as by applying a suitable feature detection algorithm and/or a suitable feature description algorithm to the image. For example, identifying module 106 may detect at least one image feature included in image 210, and may generate one or more feature descriptors based on the detected image feature, by applying an ORB feature detection and feature description algorithm to the image. This may result in at least one feature descriptor that may describe a feature included in the captured image. Identifying module 106 may then include the feature vector as at least part of biometric identifier 212.

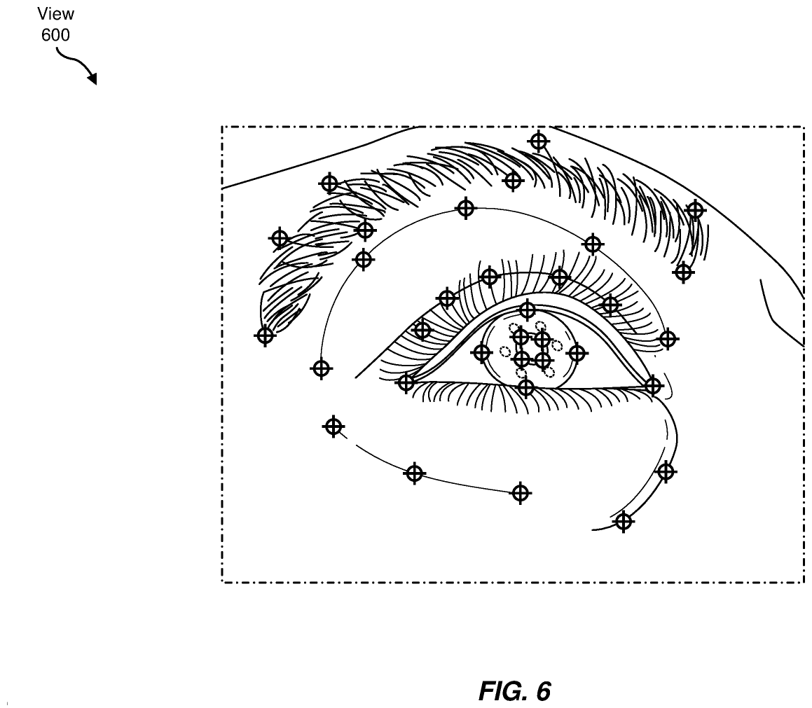

By way of illustration, FIG. 6 shows an example image 600, which is similar to example image 500 in FIG. 5, but with various detected image features indicated by image feature indicators. A pattern of the image features may be biometrically unique to a particular user, and hence identifying module 106 may identify the user based on a feature vector that may include and/or describe a relationship among image features extracted from an image of a periocular region of the user (e.g., image 210, example image 500, etc.).

In some examples, biometric identifier 212 may include a particular eye tracking movement or pattern produced by the user. This may include a user-specific saccade produced by the user in response to a particular image or light pattern. A saccade may include a quick, often involuntary, movement of one or both eyes between two or more phases of fixation in the same direction. The phenomenon may be associated with a shift in frequency of an emitted signal (e.g., a shift in frequency of light presented to an eye of a user) and/or a movement of a body part or device (e.g., motion or changes of a pattern of a light source that may present light to one or more eyes of a user).

By way of illustration, one or more of modules 102 (e.g., capturing module 104, identifying module 106, security module 108, etc.) may cause an illumination source within HMD 204 (e.g., at least one of illumination source 206(A) and/or illumination source 206(B)) to present light having a frequency, image, pattern, and so forth that may cause one or more of the user's eyes to engage in and/or execute one or more movements. These movements may be biometrically identifiable, and hence may be associated with and/or identified as at least part of biometric identifier 212. Therefore, one or more of modules 102 (e.g., capturing module 104, identifying module 106, security module 108, etc.) may capture (e.g., via camera assembly 140) data associated with the periocular region of the user when the user's eye engages in a movement or pattern (e.g., tracking motion, saccadic movement, etc.) in response to a predetermined stimulus (e.g., light having a frequency, image, pattern, and so forth). Furthermore, one or more of modules 102 may analyze the captured data associated with these movements or patterns to identify biometric identifier 212.

In some examples, identifying module 106 may identify at least one biometric identifier (e.g., biometric identifier 212) of a user based on an image (e.g., image 210) of a periocular region of the user (e.g., periocular region 208(A) and/or periocular region 208(B)) by analyzing the image of the periocular region of the user in accordance with a machine learning model trained to identify features of periocular regions of users. A “machine learning model” may include any suitable system, algorithm, and/or model that may build a mathematical model based on sample data, known as “training data”, in order to make predictions or decisions without being explicitly programmed to do so. Examples of machine learning models may include, without limitation, artificial neural networks, decision trees, support vector machines, regression analysis, Bayesian networks, genetic algorithms, and so forth.

Furthermore, examples of machine learning algorithms that may be used to construct, implement, and/or develop machine learning models may include, without limitation, supervised learning algorithms, unsupervised learning algorithms, semi-supervised learning algorithms, reinforcement learning algorithms, self learning algorithms, self learning algorithms, feature learning algorithms, sparse dictionary learning algorithms, anomaly detection algorithms, robot learning algorithms, association rule learning methods, and so forth.

In some examples, one or more of modules 102 (e.g., capturing module 104, identifying module 106, and/or security module 108) may train a machine learning model to identify features of periocular regions of users by analyzing a predetermined set of images of periocular regions of users via an artificial neural network. Artificial neural networks may learn to perform tasks by considering examples, generally—though not exclusively—without being programmed with task-specific rules. Artificial neural networks may include artificial neurons which may receive input, may combine the input with an internal state and an optional threshold using an activation function, and may produce output using an output function. The initial inputs are generally—though not exclusively-external data such as documents and images. The ultimate outputs may accomplish a given task, such as recognizing an object in an image. In some examples, an artificial neural network may include a “convolutional neural network” that may employ one or more convolution mathematical operations.

Hence, in some examples, one or more of modules 102 may identify a biometric identifier of a user based on an image of a periocular region of the user by analyzing the image (e.g., image 210) in accordance with a machine learning model trained to identify features of periocular regions of users. In some examples, one or more of modules 102 may further train the machine learning model to identify features of periocular regions of users by analyzing a predetermined set of images of periocular regions of users via an artificial neural network.

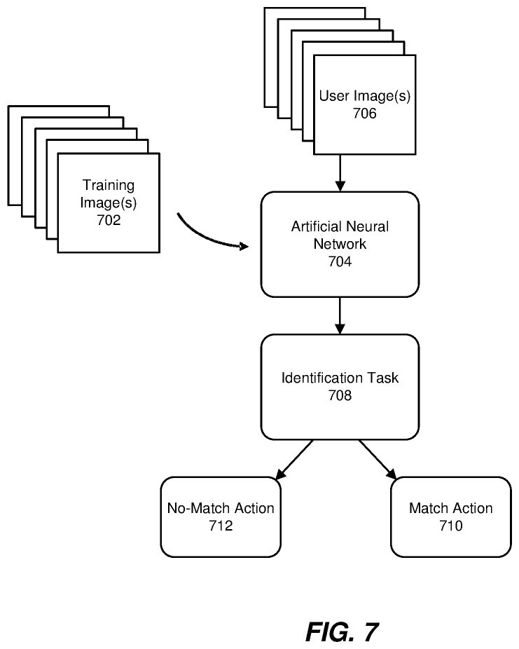

By way of illustration, FIG. 7 is a flow diagram of an example implementation of a method for authenticating a user of an HMD. As shown, one or more of modules 102 may input training images 702 into artificial neural network 704. Training images 702 may include a set of images that may include one or more periocular regions of one or more users. One or more of modules 102 may cause artificial neural network to analyze training images 702, thus causing artificial neural network 704 to be conditioned, trained, and/or prepared to recognize one or more features of periocular regions of users.

One or more of modules 102 (e.g., identifying module 106) may also analyze one or more user images 706 via artificial neural network 704 as part of an identification task 708. Based on the analysis of user images 706 by trained artificial neural network 704, one or more of modules 102 may either identify a user's periocular region from one or more of user images 706 or may not identify the user's periocular region from one or more of user images 706. If the one or more modules 102 identify the user based on the analysis of user images 706 by trained artificial neural network 704, one or more of modules 102 (e.g., security module 108) may execute a match action 710. If the one or more modules 102 do not identify the user based on the analysis of user images 706 by trained artificial neural network 704, one or more of user modules 102 (e.g., security module 108) may execute a no-match action 712.

Returning to FIG. 3, at step 330, one or more of the systems described herein may perform at least one security action based on identifying a biometric identifier included in an image of a periocular region of a user. For example, security module 108 may, as part of computing device 202 in FIG. 2, perform security action 214 based on identifying module 106 identifying biometric identifier 212 included in image 210 of periocular region 208 (e.g., periocular region 208(A) and/or periocular region 208(B)).

In some examples, a “security action” may generally refer to any action that may prevent unauthorized access of a feature of an HMD (e.g., HMD 204). Security module 108 may perform security action 214 in a variety of contexts. In some examples, security module 108 may determine that biometric identifier 212 satisfies any suitable authentication criterion. In some examples, the authentication criterion may be outside of a known iris recognition standard (e.g., ISO/IEC Standard 29794-6:2015).

By way of illustration, in at least one embodiment, biometric identifier 212 may include a feature vector extracted from image 210 of periocular region 208. A possible suitable authentication criterion (e.g., an authentication criterion outside of ISO/IEC Standard 29794-6:2015) may include a determination that a test feature vector, such as a feature vector included in biometric identifier 212, has greater than a threshold degree of similarity to a known feature vector, such as a feature vector captured, generated, created, and/or calculated as part of an enrollment process that may precede the identification process. Security module 108 may compare the feature vector included in biometric identifier 212 to the known feature vector and may determine that the feature vector included in biometric identifier 212 and the known feature vector have greater than the threshold degree of similarity, and hence may determine that biometric identifier 212 satisfies the authentication criterion. Security module 108 may then perform security action 214 based on that determination.

As another example, in accordance with a Daugman-type process described above in reference to identifying module 106, a suitable authentication criterion outside of a known iris recognition standard may be a determination that a test iris code, derived from an image of a periocular region including at least one attribute outside of a range included in a predefined iris recognition standard (e.g., an image that does not meet a criterion included in ISO/IEC Standard 29794-6:2015), matches (e.g., has greater than a threshold degree of similarity with) a predetermined iris code (e.g., an already-known iris code, such as from a previous iris capture and/or recognition process).

Hence, in some examples, biometric identifier 212 may include an iris code derived from an image of a periocular region that may not meet at least one criterion included in ISO/IEC Standard 29794-6:2015, such as a minimum resolution, a maximum optical distortion, an iris-pupil ratio, and so forth. One or more of modules 102 (e.g., identifying module 106 and/or security module 108) may compute a Hamming Distance between the iris code and predetermined iris code as described above. Security module 108 may further determine, based on the Hamming Distance between the iris code included in biometric identifier 212 and the predetermined iris code, that biometric identifier 212 satisfies the authentication criterion. Security module 108 may then perform security action 214 based on that determination.

Additionally, in some embodiments, security module 108 may generate an incident report regarding an attempt to access HMD 204. Such an incident report may serve to notify an administrator that an access incident (e.g., an authorized access and/or a prevention of unauthorized access) regarding HMD 204 has occurred, and/or may provide the administrator with information to appropriately respond to the access incident. The incident report may include, but is not limited to, at least one of (1) an identifier associated with HMD 204 (2) an identifier associated with the user, (3) a copy of image 210 and/or any other data captured by HMD 204 during the access incident, and/or (4) any other suitable data that may memorialize the access incident.

In some embodiments, security module 108 may perform security action 214 based on any combination of biometric data and/or identifiers that may include biometric identifier 212. In some examples, one or more of modules 102 (e.g., capturing module 104, identifying module 106, and/or security module 108) may gather, via various additional biometric sensors, various additional biometric data, such as a body temperature, a voice biometric, a heart rate, an electromyogram, and so forth. Security module 108 may perform security action 214 further based on this additional biometric data. For example, a user may have a resting heart rate within a predetermined range. One or more of modules 102 (e.g., capturing module 104, identifying module 106, and/or security module 108) may gather (e.g., via a heart rate monitor) a heart rate of the user and/or biometric identifier 212, may determine that the heart rate of the user is within the predetermined range, and that biometric identifier 212 satisfies the authentication criterion. Hence, security module 108 may perform security action 214 based on any combination of biometric data and/or identifiers that may include biometric identifier 212.

In some embodiments, security module 108 may perform security action 214 based on identifying of biometric identifier 212 in combination with any other suitable user input, such as a password, a personal identification number, a tactile input, and so forth. For example, although not shown in FIG. 1 or FIG. 2, embodiments of the systems disclosed herein may include a tactile input device. One or more of modules 102 (e.g., capture module 104, identifying module 106, security module 108, etc.) may receive a tactile input (e.g., a particular tactile input sequence such as a Morse code sequence) from a user that may match a predetermined tactile input (e.g., a predetermined pattern, a predetermined Morse code sequence, etc.). In such an example, security module 108 may perform security action 214 based on the identifying of biometric identifier 212 in combination with the received tactile input matching the predetermined tactile input.

In some examples, one or more of the systems described herein (e.g., one or more of modules 102) may perform one or more of the operations described herein while an HMD (e.g., HMD 204) is in an authentication mode. In some examples, an authentication mode may be any configuration of an HMD wherein one or more components of the HMD may facilitate one or more of the operations described herein and that may be distinct from an additional operational mode of the HMD. When in an authentication mode, one or more components included in one or more of the systems described herein may operate in a way that may differ from a way that the one or more components may operate when the one or more systems is in an additional operational mode. For example, when in an authentication mode, an HMD (e.g., HMD 204) may be configured to perform one or more of the operations described herein. Once a security action (e.g., security action 214) has been performed, or as part of the security action (e.g., once a user has been authenticated), the HMD may transition to an operational mode, wherein one or more components included in the HMD may be configured differently than when in the authentication mode.

Continuing with this illustration, when the HMD in the authentication mode, one or more components of the HMD may operate differently than when the HMD is in the operational mode. For example, an illumination source included in the HMD (e.g., illumination source 206) may be configured to provide a different illumination (e.g., a different wavelength of illumination, a different pattern of illumination, a different motion of illumination, etc.) when the HMD is in the authentication mode than when the HMD is in the operational mode. This authentication mode or configuration may facilitate and/or support any of the operations described herein to capture an image of the periocular region of the user, identify at least one biometric identifier included in the image of the periocular region of the user, and/or perform at least one security action based on identifying the biometric identifier included in the image of the periocular region of the user.

In some examples, a security action (e.g., security action 214) may include transitioning the HMD from the authentication mode to an operational mode based on identifying of the biometric identifier included in the image of the periocular region of the user. For example, when in the authentication mode, illumination source 206 may be in an authentication configuration (e.g., configured to present a particular pattern, type, and/or wavelength of illumination to a periocular region of a user). As part of security action 214, one or more of modules 102 (e.g., capturing module 104, identifying module 106, and/or security module 108) may transition illumination source 206 from the authentication configuration to an operational configuration (e.g., configure illumination source 206 to present a different pattern, type, and/or wavelength of illumination to the periocular region of a user).

By executing one or more security actions, the systems and methods described herein may provide an authorized user with access to one or more features of HMD 204, such as an operating system/environment, an application, user and/or system data, and so forth. Additionally, the systems and methods described herein may prevent an unauthorized user from accessing one or more features of HMD 204. Furthermore, the systems and methods described herein may educate a user of HMD 204 regarding authorized access to HMD 204, such as by presenting a prompt instructing an unauthorized user of HMD 204 to execute an enrollment process to become an authorized user of HMD 204.

As mentioned above, in some examples, HMD 204 may include a waveguide display. Accordingly, illumination source 206 (e.g., illumination source 206(A) and/or illumination source 206(B)) may illuminate periocular region 208 (e.g., periocular region 208(A) and/or periocular region 208(B)) via an optical pathway of the waveguide display. Furthermore, camera assembly 140 may receive light reflected by periocular region 208 (e.g., periocular region 208(A) and/or periocular region 208(B)) via the optical pathway of the waveguide display.

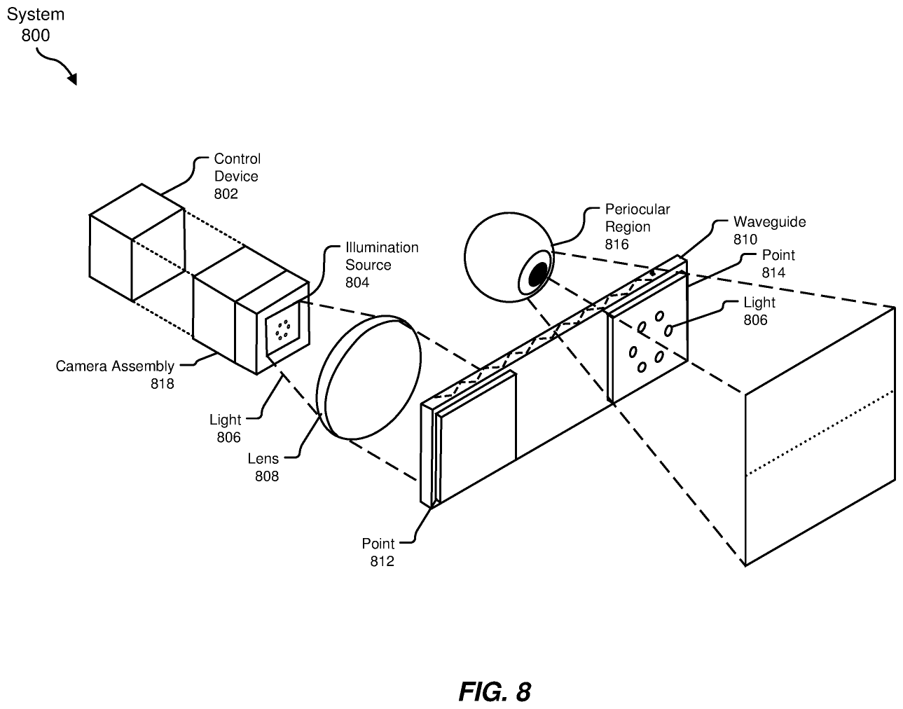

To illustrate, FIG. 8 is a block diagram of an example system 800 that includes a waveguide display. As shown, example system 800 includes a control device 802 that may perform any of the operations described herein associated with control device 202. Example system 800 may also include an illumination source 804 that may include any of the possible illumination sources described herein. For example, illumination source 804 may include a rolling-shutter display or a global-shutter display. In additional examples, illumination source 804 may include an infrared light source, such as an infrared VCSEL, and a MEMS micromirror device that may be configured to scan the infrared light source across a surface (e.g., a periocular region).

Illumination source 804 may generate and/or produce light 806 that may pass through a lens assembly 808 (“lens 808” in FIG. 8), which may represent one or more optical elements that may direct light 806 into waveguide 810. Waveguide 810 may include any suitable waveguide that may guide electromagnetic signals in a portion of the electromagnetic spectrum from a first point (e.g., point 812) to a second point (e.g., point 814) via any suitable mechanism, such as internal reflection, Bragg reflection, and so forth. Hence, waveguide 810 may guide light from point 812 to point 814 and/or from point 814 to point 812. Light may exit waveguide 810 at point 814, and waveguide 810 and/or any other suitable optical elements (e.g., a combiner lens) may direct the light towards a periocular region of a user, such as periocular region 816. Likewise, light may exit waveguide 810 at point 812, and waveguide 810 may direct the exiting light toward a camera assembly 818 (e.g., via lens 808). As described above, camera assembly 818 may include any suitable image sensor such as an event camera, a rolling-shutter camera, a global shutter camera, and so forth.

Hence, one or more of modules 102 (e.g., capturing module 104) may direct illumination source 804 to illuminate a portion of a periocular region of a user by directing illumination source 804 to generate and/or produce light 806 and direct light 806 toward point 812 of waveguide 810. Light 806 may enter waveguide 810, and waveguide 810 may guide light 806 toward point 814. Upon exiting waveguide 810 at point 814, light 806 may illuminate at least a portion of periocular region 816.

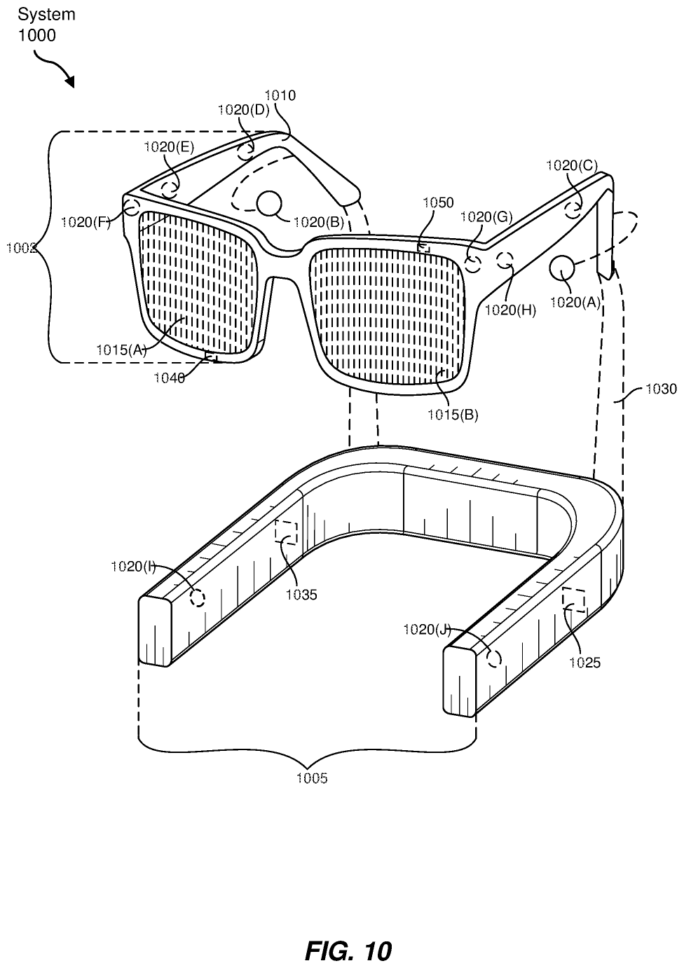

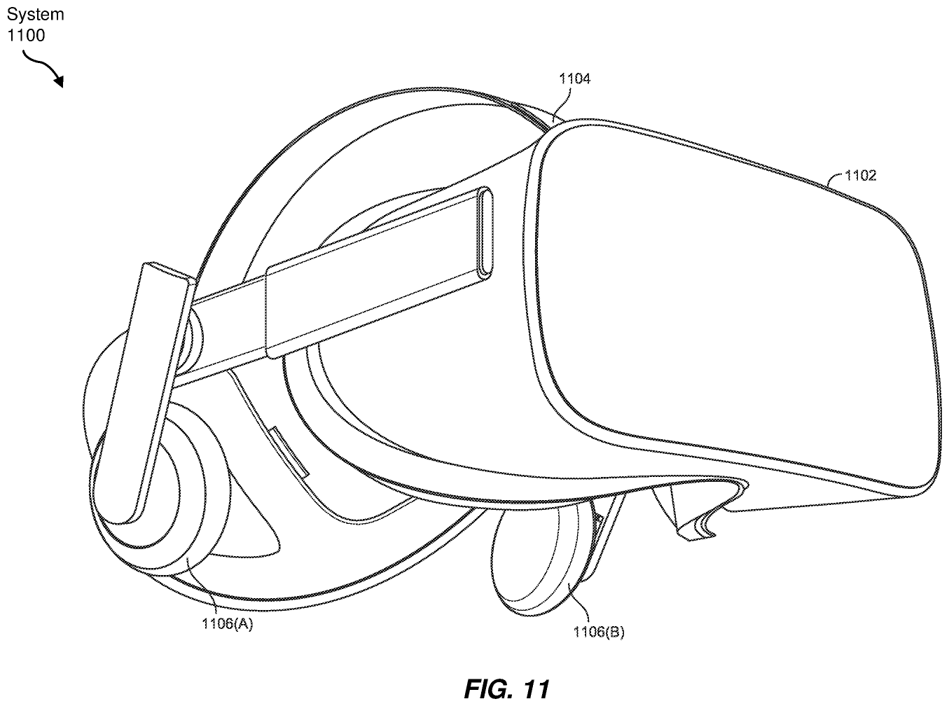

Furthermore, periocular region 816 may reflect light back into waveguide 810 at point 814. Waveguide 810 may guide the reflected light toward point 812, where the reflected light may exit waveguide 810 and/or pass into lens assembly 808. Lens assembly 808 may direct the reflected light toward camera assembly 818. Capturing module 104 may therefore capture, via camera assembly 818, a portion of the light reflected by periocular region 816 as an image of periocular region 816 (e.g., image 210). Identifying module 106 may identify a biometric identifier included in the image of the periocular region of the user in any of the ways described herein, and security module 108 may perform at least one security action based on identifying module 106 identifying the biometric identifier included in the image of the periocular region of the user. Additional examples of waveguides and/or waveguide displays may be described below in reference to FIGS. 10-11.

Embodiments of the present disclosure may include or be implemented in conjunction with various types of artificial reality systems. Artificial reality is a form of reality that has been adjusted in some manner before presentation to a user, which may include, e.g., a virtual reality, an augmented reality, a mixed reality, a hybrid reality, or some combination and/or derivative thereof. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs), an example of which is augmented-reality system 900 in FIG. 9. Other artificial reality systems may include a NED that also provides visibility into the real world (e.g., augmented-reality system 1000 in FIG. 10) or that visually immerses a user in an artificial reality (e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 generally represents a wearable device dimensioned to fit about a body part (e.g., a head) of a user. As shown in FIG. 9, system 900 may include a frame 902 and a camera assembly 904 that is coupled to frame 902 and configured to gather information about a local environment by observing the local environment. Augmented-reality system 900 may also include one or more audio devices, such as output audio transducers 908(A) and 908(B) and input audio transducers 910. Output audio transducers 908(A) and 908(B) may provide audio feedback and/or content to a user, and input audio transducers 910 may capture audio in a user's environment.

As shown, augmented-reality system 900 may not necessarily include a NED positioned in front of a user's eyes. Augmented-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While augmented-reality system 900 may not include a NED, augmented-reality system 900 may include other types of screens or visual feedback devices (e.g., a display screen integrated into a side of frame 902).

The embodiments discussed in this disclosure may also be implemented in augmented-reality systems that include one or more NEDs. For example, as shown in FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent a position sensor, an inertial measurement unit (IMU), a depth camera assembly, a touch sensor, a proximity sensor, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, touch sensors, proximity sensors, heat/temperature sensors, biometric sensors, other suitable types of sensors that detect motion, sensors used for error correction of the IMU, or some combination thereof.

Augmented-reality system 1000 may also include a microphone array with a plurality of acoustic transducers 1020(A)-1020(J), referred to collectively as acoustic transducers 1020. Acoustic transducers 1020 may be transducers that detect air pressure variations induced by sound waves. Each acoustic transducer 1020 may be configured to detect sound and convert the detected sound into an electronic format (e.g., an analog or digital format). The microphone array in FIG. 2 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(F) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by the controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer, or some combination thereof.

Acoustic transducers 1020(A) and 1020(B) may be positioned on different parts of the user's ear, such as behind the pinna or within the auricle or fossa. Or, there may be additional acoustic transducers on or surrounding the ear in addition to acoustic transducers 1020 inside the ear canal. Having an acoustic transducer positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments, acoustic transducers 1020(A) and 1020(B) may be connected to augmented-reality system 1000 via a wireless connection (e.g., a Bluetooth connection). In still other embodiments, acoustic transducers 1020(A) and 1020(B) may not be used at all in conjunction with augmented-reality system 1000.

Acoustic transducers 1020 on frame 1010 may be positioned along the length of the temples, across the bridge, above or below display devices 1015(A) and 1015(B), or some combination thereof. Acoustic transducers 1020 may be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers and other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof. Furthermore,

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUS), one or more tracking emitters or detectors, one or more touch sensors, one or more proximity sensors, and/or any other suitable sensor, device, or system for creating an artificial reality experience.

Artificial reality systems may include a variety of types of visual feedback mechanisms. For example, display devices in augmented-reality system 1100 and/or virtual-reality system 1100 may include one or more liquid crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems may also include optical subsystems having one or more lenses (e.g., conventional concave or convex lenses, Fresnel lenses, adjustable liquid lenses, etc.) through which a user may view a display screen.

In addition to or instead of using display screens, some artificial reality systems may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, augmented-reality system 900, augmented-reality system 1000, and/or virtual-reality system 1100 may include one or more optical sensors, such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 9 and 11, output audio transducers 908(A), 908(B), 1106(A), and 1106(B) may include voice coil speakers, ribbon speakers, electrostatic speakers, piezoelectric speakers, bone conduction transducers, cartilage conduction transducers, and/or any other suitable type or form of audio transducer. Similarly, input audio transducers 910 may include condenser microphones, dynamic microphones, ribbon microphones, and/or any other type or form of input transducer. In some embodiments, a single transducer may be used for both audio input and audio output.

While not shown in FIGS. 9-11, artificial reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visuals aids, etc.). The embodiments disclosed herein may enable or enhance a user's artificial reality experience in one or more of these contexts and environments and/or in other contexts and environments.

In some embodiments, one or more of the systems described herein (e.g., one or more of modules 102) may detect that the user has donned an HMD and may execute one or more operations described herein in response to detecting that the user has donned the HMD. For example, as described above in connection with FIGS. 2 and 9-11, one or more artificial reality systems (e.g., example system 200 in FIG. 2, augmented-reality system 1000 in FIG. 10, virtual-reality system 1100 in FIG. 11, etc.) may include one or more inertial measurement units (IMUS), one or more tracking emitters or detectors, one or more touch sensors, one or more proximity sensors, one or more temperature sensors, one or more biometric sensors, and so forth. One or more of modules 102 may detect, via one or more of these sensors, that a user has donned an HMD. In response to detecting that the user has donned the HMD, one or more of modules 102 may execute any of the operations described herein. For example, capturing module 104 may capture image 210 in response to one or more of modules 102 (e.g., capturing module 104, identifying module 106, etc.) detecting that the user has donned HMD 204.

Furthermore, one or more of modules 102 may, in some embodiments, detect that camera assembly 140 is in a suitable position (e.g., relative to a periocular region 208) to capture an image of a periocular region 208 (e.g., periocular region 208(A) and/or periocular region 208(B). For example, capturing module 104 may detect, via one or more sensors and/or camera assemblies (e.g., camera assembly 140) that may be included in HMD 204, that camera assembly 140 is in a suitable position relative to a periocular region 208 (e.g., periocular region 208(A) and/or periocular region 208(B)) to capture an image of a periocular region 208. In response, one or more of modules 102 may execute any of the operations described herein. For example, capturing module 104 may capture image 210 via camera assembly 140 in response to one or more of modules 102 (e.g., capturing module 104, identifying module 106, etc.) detecting that camera assembly 140 is in a suitable position to capture image 210 of periocular region 208 (e.g., periocular region 208(A) and/or periocular region 208(B)).

As discussed throughout the instant disclosure, the disclosed systems and methods may provide one or more advantages over traditional options for authenticating a user of an HMD. For example, by identifying biometric identifiers of users of HMDs, the systems and methods described herein may improve security and/or personalization of artificial reality experiences presented via HMDs. Furthermore, by using existing camera assemblies that may already be included in HMDs (e.g., for eye tracking and other purposes) for biometric user authentication, the systems and methods described herein may improve user authentication while minimizing cost and/or complexity of HMD designs and/or implementations.

### EXAMPLE EMBODIMENTS

### Example 1

A computer-implemented method of authenticating a user comprising (1) capturing, via a camera assembly included in an HMD and configured to receive light reflected from a periocular region of a user, an image of the periocular region of the user, the image of the periocular region of the user comprising at least one attribute that is outside of a range defined in a known iris recognition standard, (2) identifying at least one biometric identifier included in the image of the periocular region of the user, and (3) performing at least one security action based on identifying the biometric identifier included in the image of the periocular region of the user.

### Example 2

The computer-implemented method of example 1, wherein (1) the computer-implemented method further comprises determining that the at least one biometric identifier included in the image of the periocular region of the user satisfies an authentication criterion outside the known iris recognition standard, and (2) performing the at least one security action based on identifying the biometric identifier included in the image of the periocular region of the user comprises performing the at least one security action based on the determination that the least one biometric identifier included in the image of the periocular region of the user satisfies the authentication criterion.

### Example 3

The computer-implemented method of any of examples 1-2, wherein the attribute of the image of the periocular region of the user comprises at least one of (1) a resolution of the image comprises less than 640 pixels by 480 pixels, (2) a spatial sampling rate of the image comprises fewer than 15.7 pixels per millimeter, (3) a pixel aspect ratio of the image comprises at least one of (a) a ratio of less than 0.991, or (b) a ratio of greater than 1.011, (4) an optical distortion of the image is greater than a predetermined optical distortion threshold, (5) a sharpness of the image is less than a predetermined sharpness threshold, or (6) a sensor signal-to-noise ratio of the image is less than 36 dB.

### Example 4

The computer-implemented method of any of examples 1-3, wherein the attribute of the image comprises a content of the image, the content of the image comprising a portion of an iris of the user and at least one of (1) the portion of the iris of the user comprises less than 70 percent of the iris of the user, (2) a radius of the portion of the iris of the user comprises fewer than 80 pixels, or (3) the content of the image further comprises a pupil of the user, and at least one of (a) a concentricity of the portion of the iris and the portion of the pupil is less than 90 percent, or (b) a ratio of the portion of the iris to the portion of the pupil is less than 20 percent or greater than 70 percent.

### Example 5

The computer-implemented method of any of examples 1-4, wherein the HMD comprises a waveguide display.

### Example 6

The computer-implemented method of example 5, wherein the camera assembly is positioned to receive light reflected by the periocular region of the user via an optical pathway of the waveguide display.

### Example 7

The computer-implemented method of any of examples 1-6, wherein the security action comprises at least one of (1) providing the user with access to a feature of the HMD, or (2) preventing the user from accessing the feature of the HMD.

### Example 8

The computer-implemented method of any of examples 1-7, wherein identifying the at least one biometric identifier of the user based on the image of the periocular region of the user comprises analyzing the image of the periocular region of the user in accordance with a machine learning model trained to identify features of periocular regions of users.

### Example 9

The computer-implemented method of example 8, further comprising training the machine learning model to identify features of periocular regions of users by analyzing a predetermined set of images of periocular regions of users via an artificial neural network.

### Example 10

The computer-implemented method of any of examples 1-9, wherein the biometric identifier comprises a pattern of an iris of the user.

### Example 11

The computer-implemented method of any of examples 1-10, wherein (1) identifying the biometric identifier of the user based on the image of the periocular region of the user comprises extracting a feature vector from the image of the periocular region of the user, and (2) the biometric identifier comprises the feature vector extracted from the image of the periocular region of the user.

### Example 12

The computer-implemented method of any of examples 1-11, wherein the known iris recognition standard comprises at least a portion of International Organization for Standardization/International Electrotechnical Commission Standard 29794-62015, entitled “Information technology—Biometric sample quality—Part 6: Iris image data”.

### Example 13

The computer-implemented method of any of examples 1-12, wherein (1) the computer-implemented method further comprises detecting that the user has donned the head-mounted display, and (2) capturing the image of the periocular region of the user comprises capturing the image of the periocular region of the user in response to detecting that the user has donned the head-mounted display.

### Example 14

A system comprising (1) an HMD comprising a camera assembly configured to receive light reflected from a periocular region of a user, (2) a capturing module, stored in memory, that captures, via the camera assembly, an image of the periocular region of the user comprising at least one attribute that is outside of a range defined in a known iris recognition standard, (3) an identifying module, stored in memory, that identifies at least one biometric identifier included in the image of the periocular region of the user, (4) a security module, stored in memory, that performs at least one security action based on identifying the biometric identifier included in the image of the periocular region of the user, and (5) at least one physical processor that executes the capturing module, the identifying module, and the security module.

### Example 15

The system of example 14, wherein the security module (1) further determines that the at least one biometric identifier included in the image of the periocular region of the user satisfies an authentication criterion outside the known iris recognition standard, and (2) performs the at least one security action based on the determination that the least one biometric identifier included in the image of the periocular region of the user satisfies the authentication criterion.

### Example 16

The system of any of examples 14-15, wherein the HMD further comprises a waveguide display.

### Example 17

The system of example 16, wherein the camera assembly is positioned to receive light reflected by the periocular region of the user via an optical pathway of the waveguide display.

### Example 18

The system of any of examples 14-17, wherein the identifying module identifies the at least one biometric identifier of the user based on the image of the periocular region of the user by analyzing the image of the periocular region of the user in accordance with a machine learning model trained to identify features of periocular regions of users.

### Example 19

The system of example 18, wherein the identifying module further trains the machine learning model to identify features of periocular regions of users by analyzing a predetermined set of images of periocular regions of users via an artificial neural network.

### Example 20

A non-transitory computer-readable medium comprising computer-readable instructions that, when executed by at least one processor of a computing system, cause the computing system to (1) capture, via a camera assembly included in an HMD and configured to receive light reflected from a periocular region of a user, an image of the periocular region of the user, the image of the periocular region of the user comprising at least one attribute that is outside of a range defined in a known iris recognition standard, (2) identify at least one biometric identifier included in the image of the periocular region of the user, and (3) perform at least one security action based on identifying the biometric identifier included in the image of the periocular region of the user.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data, output a result of the transformation to identify a biometric identifier, use the result of the transformation to identify the biometric identifier, and store the result of the transformation to identify the biometric identifier and/or an additional biometric identifier. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method of authenticating a user comprising:
capturing, via a camera assembly included in a head-mounted display (HMD) and configured to receive light reflected from a periocular region of a user, an image of the periocular region of the user, the image of the periocular region of the user comprising at least one attribute that is outside of a range defined in a known iris recognition standard;
identifying at least one biometric identifier included in the image of the periocular region of the user; and
performing at least one security action based on identifying the biometric identifier included in the image of the periocular region of the user.

2. The computer-implemented method of claim 1, wherein:
the computer-implemented method further comprises determining that the at least one biometric identifier included in the image of the periocular region of the user satisfies an authentication criterion outside the known iris recognition standard; and
performing the at least one security action based on identifying the biometric identifier included in the image of the periocular region of the user comprises performing the at least one security action based on the determination that the least one biometric identifier included in the image of the periocular region of the user satisfies the authentication criterion.

3. The computer-implemented method of claim 1, wherein the attribute of the image of the periocular region of the user comprises at least one of:
a resolution of the image comprises less than 640 pixels by 480 pixels;
a spatial sampling rate of the image comprises fewer than 15.7 pixels per millimeter;
a pixel aspect ratio of the image comprises at least one of:
a ratio of less than 0.99:1; or
a ratio of greater than 1.01:1;
an optical distortion of the image is greater than a predetermined optical distortion threshold;
a sharpness of the image is less than a predetermined sharpness threshold; or
a sensor signal-to-noise ratio of the image is less than 36 dB.

4. The computer-implemented method of claim 1, wherein the attribute of the image comprises a content of the image, the content of the image comprising a portion of an iris of the user and at least one of:
the portion of the iris of the user comprises less than 70 percent of the iris of the user;
a radius of the portion of the iris of the user comprises fewer than 80 pixels; or
the content of the image further comprises a pupil of the user; and at least one of:
a concentricity of the portion of the iris and the portion of the pupil is less than 90 percent; or
a ratio of the portion of the iris to the portion of the pupil is less than 20 percent or greater than 70 percent.

5. The computer-implemented method of claim 1, wherein the HMD comprises a waveguide display.

6. The computer-implemented method of claim 5, wherein the camera assembly is positioned to receive light reflected by the periocular region of the user via an optical pathway of the waveguide display.

7. The computer-implemented method of claim 1, wherein the security action comprises at least one of:
providing the user with access to a feature of the HMD; or
preventing the user from accessing the feature of the HMD.

8. The computer-implemented method of claim 1, wherein identifying the at least one biometric identifier of the user based on the image of the periocular region of the user comprises analyzing the image of the periocular region of the user in accordance with a machine learning model trained to identify features of periocular regions of users.

9. The computer-implemented method of claim 8, further comprising training the machine learning model to identify features of periocular regions of users by analyzing a predetermined set of images of periocular regions of users via an artificial neural network.

10. The computer-implemented method of claim 1, wherein the biometric identifier comprises a pattern of an iris of the user.

11. The computer-implemented method of claim 1, wherein:
identifying the biometric identifier of the user based on the image of the periocular region of the user comprises extracting a feature vector from the image of the periocular region of the user; and
the biometric identifier comprises the feature vector extracted from the image of the periocular region of the user.

12. The computer-implemented method of claim 1, wherein the known iris recognition standard comprises at least a portion of International Organization for Standardization/International Electrotechnical Commission Standard 29794-6:2015, entitled “Information technology Biometric sample quality Part 6: Iris image data”.

13. The computer-implemented method of claim 1, wherein:
the computer-implemented method further comprises detecting that the user has donned the head-mounted display; and
capturing the image of the periocular region of the user comprises capturing the image of the periocular region of the user in response to detecting that the user has donned the head-mounted display.

14. A system comprising:
a head-mounted display (HMD) comprising a camera assembly configured to receive light reflected from a periocular region of a user;
a capturing module, stored in memory, that captures, via the camera assembly, an image of the periocular region of the user comprising at least one attribute that is outside of a range defined in a known iris recognition standard;
an identifying module, stored in memory, that identifies at least one biometric identifier included in the image of the periocular region of the user;
a security module, stored in memory, that performs at least one security action based on identifying the biometric identifier included in the image of the periocular region of the user; and
at least one physical processor that executes the capturing module, the identifying module, and the security module.

15. The system of claim 14, wherein the security module:
further determines that the at least one biometric identifier included in the image of the periocular region of the user satisfies an authentication criterion outside the known iris recognition standard; and
performs the at least one security action based on the determination that the least one biometric identifier included in the image of the periocular region of the user satisfies the authentication criterion.

16. The system of claim 14, wherein the HMD further comprises a waveguide display.

17. The system of claim 16, wherein the camera assembly is positioned to receive light reflected by the periocular region of the user via an optical pathway of the waveguide display.

18. The system of claim 14, wherein the identifying module identifies the at least one biometric identifier of the user based on the image of the periocular region of the user by analyzing the image of the periocular region of the user in accordance with a machine learning model trained to identify features of periocular regions of users.

19. The system of claim 18, wherein the identifying module further trains the machine learning model to identify features of periocular regions of users by analyzing a predetermined set of images of periocular regions of users via an artificial neural network.

20. A non-transitory computer-readable medium comprising computer-readable instructions that, when executed by at least one processor of a computing system, cause the computing system to:
capture, via a camera assembly included in a head-mounted display (HMD) and configured to receive light reflected from a periocular region of a user, an image of the periocular region of the user, the image of the periocular region of the user comprising at least one attribute that is outside of a range defined in a known iris recognition standard;
identify at least one biometric identifier included in the image of the periocular region of the user; and
perform at least one security action based on identifying the biometric identifier included in the image of the periocular region of the user.
